(19) United States
(12) Patent Application Publication
(10) Pub. No.: US 2011/0214081 A1
(43) Pub. Date: Sep. 1, 2011

(54) SYSTEMS AND METHODS FOR FLEXIBLY SCHEDULED DASHBOARD CREATION

(75) Inventors: Adrian Serban Dobrin, Toronto (CA); Troy A. Marchand, Nobleton (CA)

(73) Assignee: DUNDAS DATA VISUALIZATION, INC., Toronto (CA)

(21) Appl. No.: 13/036,443

(22) Filed: Feb. 28, 2011

Related U.S. Application Data
(60) Provisional application No. 61/309,197, filed on Mar. 1, 2010.

(51) Int. Cl. G06F 3/048

(52) U.S. Cl. 715/771

(57) ABSTRACT

The described embodiments relate generally to methods and systems for dashboard creation. In one embodiment, the method may include: generating a plurality of key performance indicator proxy values for a created key performance indicator record; creating a proxy link associating the key performance indicator record with the plurality of key performance indicator proxy values; creating a dashboard design displaying a graphical element corresponding to the key performance indicator record; deriving a plurality of key performance indicator values from a business database; defining a performance link and associating the key performance indicator record with the plurality of key performance indicator values using the performance link.

### PRIORITY

This application claims priority from U.S. provisional patent application No. 61/309,197, filed Mar. 1, 2010, which is incorporated by reference herein in its entirety.

### TECHNICAL FIELD

The described embodiments relate generally to methods and systems for dashboard creation.

### BACKGROUND

“Dashboards” present visualizations, for example, in graph or chart form, of key performance indicator (KPI) metrics or information derived from business values or data stored in business databases. Such visualizations may be viewed (e.g., on a computer screen or other display device) by executives to obtain an overview of how a business is performing.

Traditional dashboard creation methods can be time-consuming. A large volume of data stored in business databases may first need to be retrieved and organized in an accessible format. This process often requires a technician having database management expertise. Then, a business analyst (or person with similar business expertise) may select the appropriate data and organize it into KPIs. Subsequently, a designer may create the visual design of the dashboard by selecting and arranging graphical elements representing the KPIs.

The applicants have recognized a need for improved methods and systems for creating dashboards.

### BRIEF DESCRIPTION OF THE DRAWINGS

Embodiments are described in further detail below, by way of example only, with reference to the accompanying drawings, in which:

FIG. 1 is a block diagram of one possible configuration of a system for flexibly scheduled dashboard creation;

FIG. 2 is a flowchart illustrating a sequence of events for flexibly scheduled creation of a data visualization dashboard, in accordance with one implementation;

FIG. 3 is a schematic illustration showing example tables in a business database;

FIG. 4 is a schematic illustration showing an example KPI record with a proxy link to KPI proxy values at time A;

FIG. 5 is a schematic illustration showing the KPI proxy values linked to the KPI record of FIG. 4 at time A;

FIG. 6 is an example screenshot of a dashboard design, containing a graphical element depicting the KPI proxy values of FIG. 5;

FIG. 7 is a schematic illustration showing an example summary table containing KPI values corresponding to the KPI proxy values in FIG. 5, and linked to the KPI record of FIG. 9 at time B;

FIG. 8 is a schematic illustration of the mapping operation of an implementation application when a performance link associates the KPI record with the KPI values;

FIG. 9 is a schematic illustration showing the example KPI record of FIG. 6 with a performance link to KPI values at time B; and

FIG. 10 is an example screenshot of a completed dashboard, containing a graphical element depicting the KPI values of FIG. 7.

### DETAILED DESCRIPTION

Dashboard creation methods are typically linear and involve three steps: selection of business values from a business database, definition of key performance indicators (KPIs) from the business values, and creation of a dashboard design that contains graphical elements corresponding to the KPIs.

The embodiments described herein may relate generally to dashboard creation methods and systems that facilitate the flexible scheduling of some of the steps required to complete the creation of a dashboard.

By beginning with the specification of a key performance indicator (KPI) record and linking it with KPI proxy values via a proxy link, the KPI record and KPI proxy values can be used by a graphic designer to create a dashboard design.

The actual KPI values may be simultaneously or subsequently derived from the business database. These actual KPI values may be associated with the KR record via a performance link (in one embodiment, with the performance link replacing the proxy link), and subsequently displayed on a completed dashboard.

Since a performance link can eventually associate the KPI record 172 with the KPI values such that the KPI proxy values are no longer referenced, the KPI proxy values can be considered “stubbed”, fake or dummy data. Before the performance link is defined, the KPI record may only refer to the KPI proxy values or stubbed data. As such, the KPI record at that time may be considered a KPI proxy record or a KPI stub. In some embodiments, such KR stub record may be a different record from the eventual completed KPI record. In such case, the performance link would associate the KR values with the completed KR record 172, and not the KPI stub.

One aspect of the technology described below relates to a method for generating dashboards displaying key performance indicator information. The described method may include: creating a key performance indicator record for storing key performance indicator information; generating a plurality of key performance indicator proxy values (i.e., fake or dummy values) for simulation purposes; creating a proxy link associating the key performance indicator record with the plurality of key performance indicator proxy values; and creating a dashboard design displaying a graphical element corresponding to the key performance indicator record—the dashboard design providing a preview of the dashboard using the proxy values. In some embodiments, the dashboard design displays a plurality of graphical elements corresponding to the key performance indicator record. These one or more graphical elements may also correspond to the plurality of key performance indicator values or the key performance indicator proxy values.

The method may also include deriving a plurality of key performance indicator values from a business database (with each key performance indicator proxy value corresponding to at least one of the plurality of key performance indicator values); defining a performance link; and associating the key performance indicator record with the plurality of key performance indicator values using the performance link. In some embodiments, the business database may store business values.

In some embodiments, the key performance indicator record includes a key performance indicator graphical format for depicting the at least one graphical element. Additionally or alternatively, the method may include communicating the dashboard design to a renderer configured to render the graphical element.

In further embodiments, the deriving of key performance indicator values may include selecting a plurality of business values from the business database. In some such embodiments, the key performance indicator values may correspond to a subset of the selected plurality of the business values. Additionally or alternatively, the method may include generating a summary value (with the summary value corresponding to a subset of the selected plurality of business values) such that at least one key performance indicator value corresponds to the summary value. In some embodiments, a plurality of summary values may be generated—one or more of which may correspond to one or more key performance indicator values.

Additionally, the key performance indicator record can comprise at least one key performance indicator data property. In such case, at least one key performance indicator proxy value can conform to the at least one key performance indicator data property and/or the at least one of the derived plurality of the key performance indicator values can conform to the at least one key performance indicator data property.

Another aspect of the technology described below relates to a dashboard generated according to the method described herein.

A further aspect of the technology described below relates to a system for creating a dashboard with the dashboard displaying key performance indicator information. The described system may include: a key performance indicator record; a proxy link associating the at least one key performance indicator record with a plurality of generated key performance indicator proxy values; a business database storing a plurality of business values; a deriver operable or otherwise configured to derive a plurality of key performance indicator values from the plurality of business values (with each key performance indicator proxy value corresponding to at least one of the derived plurality of key performance indicator values); and an implementer operable or otherwise configured to: define a performance link and associate the key performance indicator record with the plurality of key performance indicator values using the performance link. In some cases, the implementer may be operable or otherwise configured to replace the proxy link with the performance link.

In some embodiments, the system may also include a renderer configured to render a dashboard design (with the dashboard design including a graphical element corresponding to the key performance indicator record).

In some instances, the key performance indicator record can include a key performance indicator graphical format for depicting the graphical element. The graphical element may correspond to one selected from the group of: the key performance indicator proxy values and the key performance indicator values. In some embodiments, there may be a plurality of graphical elements corresponding to the at least one key performance indicator record.

In some embodiments, the system can comprise a plurality of key performance indicator records. The one or more key performance indicator records may be stored in a key performance indicator storage (e.g., a database), with or without a corresponding proxy link.

In some embodiments, the deriver is operable or otherwise configured to select a plurality of business values from the business database. In such instances, the key performance indicator values may correspond to a subset of the selected plurality of business values. Additionally or alternatively, the deriver may be operable or otherwise configured to generate a summary value (with the summary value corresponding to a subset of the selected plurality of business values) so that at least one key performance indicator value corresponds to the generated summary value. In some embodiments, a plurality of summary values may be generated—one or more of which may correspond to one or more key performance indicator values.

In further embodiments, the at least one key performance indicator record may include at least one key performance indicator data property. In such case, at least one key performance indicator proxy value can conform to the at least one key performance indicator data property and/or the derived plurality of the key performance indicator values can conform to the at least one key performance indicator data property.

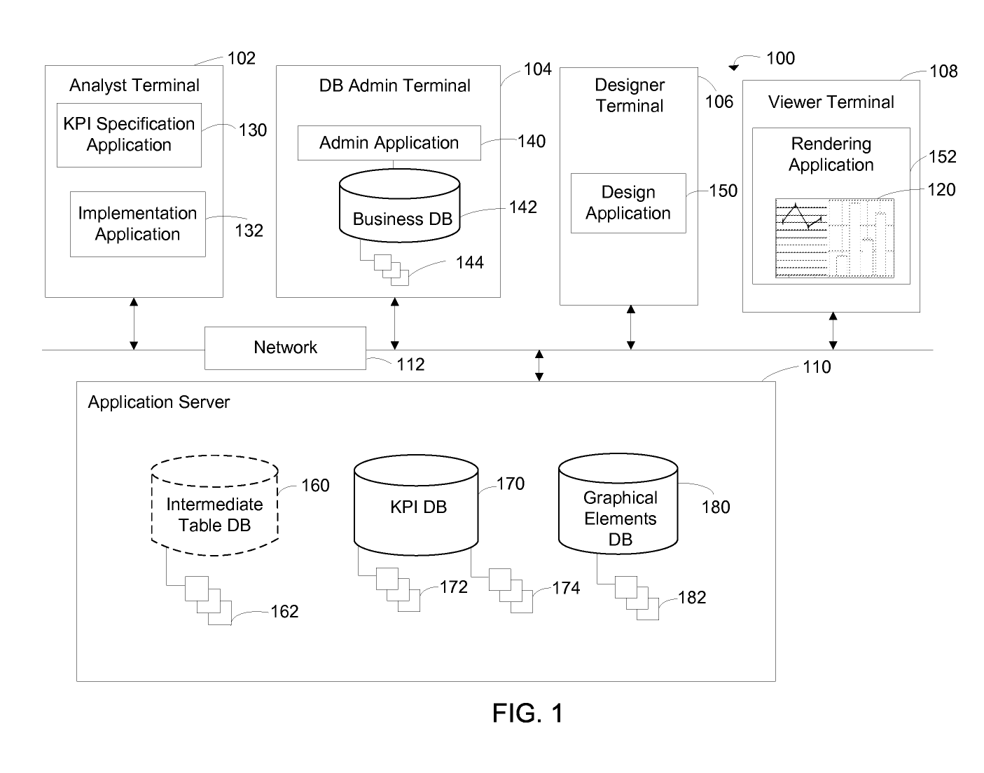

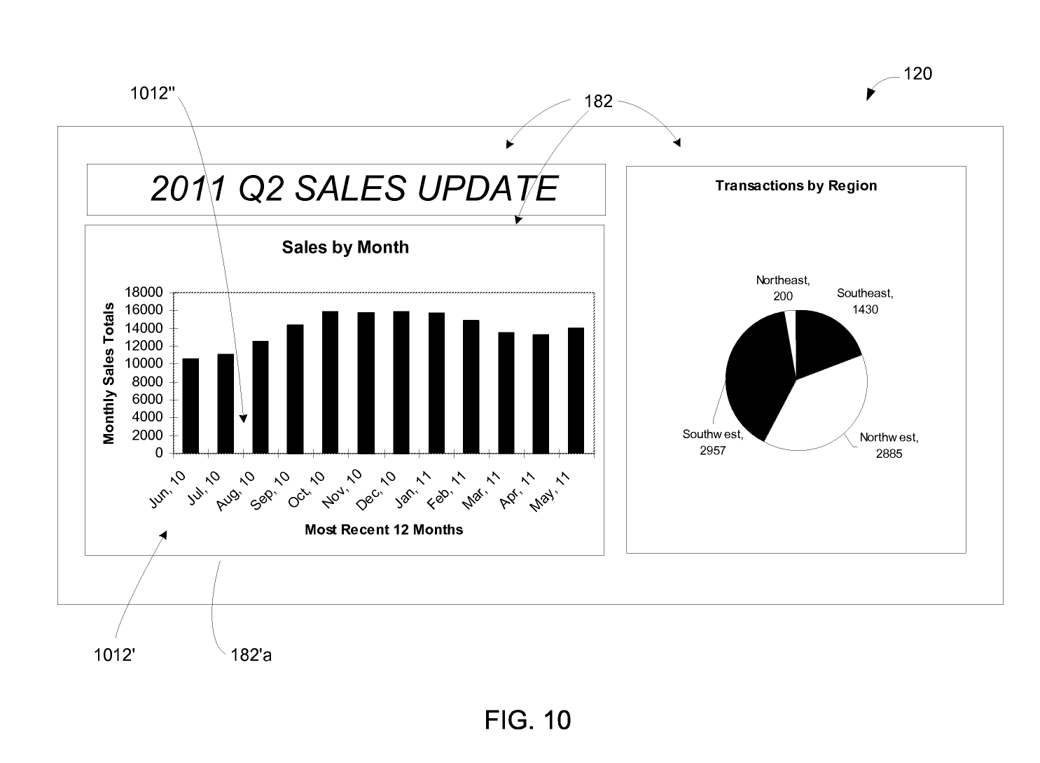

Referring to FIG. 1, a block diagram of one possible configuration of a system for flexibly scheduled dashboard creation is shown generally as 100. The implementation includes an analyst terminal 102, a database administration terminal 104, a designer terminal 106, a viewer terminal 108 (collectively, the “client” terminals) and an application server 110. Each of these components may be operatively connected to a network 112 to facilitate communication with each other. When a dashboard 120 is generated, it may be viewed on viewer terminal 108. Referring momentarily to FIG. 10, a completed dashboard 120 is illustrated.

From a high level perspective, the dashboard 120 creation process involves application server 110 providing remote software functionality to analyst terminal 102, database administration terminal 104, and designer terminal 106.

To achieve flexibly scheduled dashboard creation, a business analyst may first use analyst terminal 102 to define the business metrics for a KPI that he or she desires to view on a completed dashboard 120. KPIs may be a measurement that provides information about a business' performance such as the sales, units sold, or best selling item for a recent period of time.

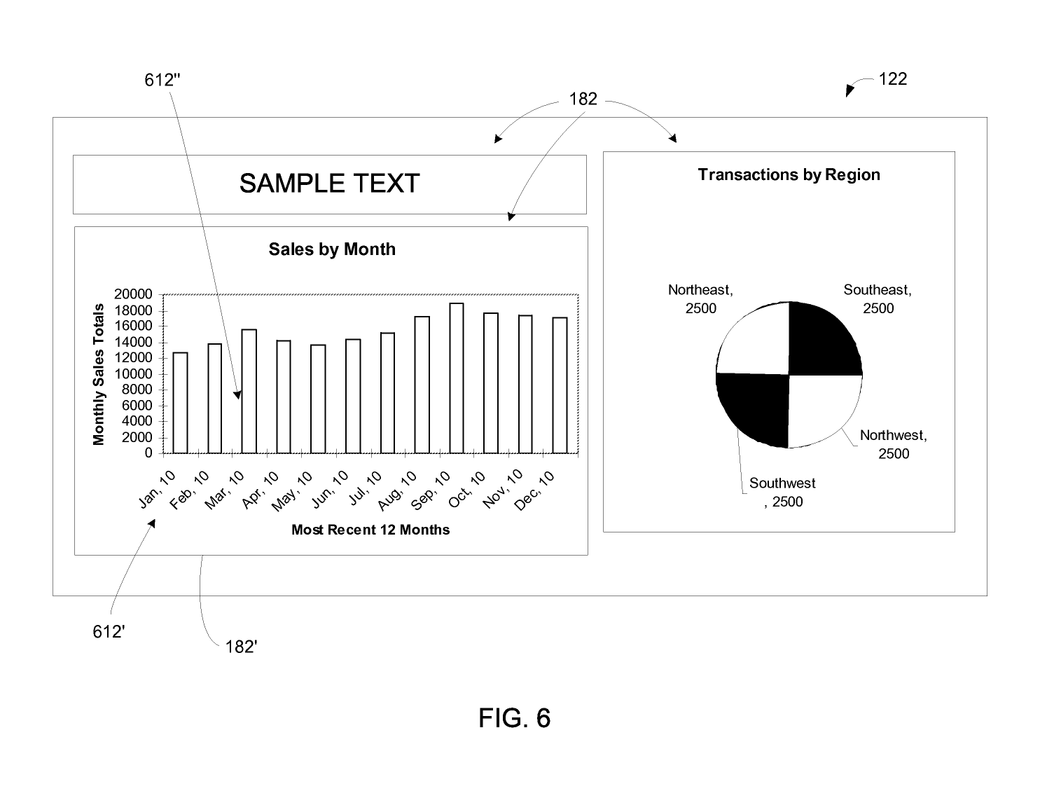

Proxy values 174 (i.e., fake, dummy or “stubbed” data for the purpose of simulation) may then be generated for the KPI. These proxy values 174 may be depicted in a graphical element of a dashboard design created by a graphic designer using designer terminal 106. By illustrating KPI proxy values 174, the graphic designer may be able to produce a dashboard design (shown as 122 in FIG. 6) that looks realistic and mimics the eventual appearance of a completed dashboard 120.

In parallel with (or after) the dashboard design process, a database administrator may derive actual KPI values 162 from a business database 142 using database administration terminal 104. When such derivation is complete, the dashboard design 122 can be configured to depict the derived KPI values instead of the proxy values 174. When this happens, the dashboard creation process is complete and actual KPI values 162 are displayed.

The dashboard 120 may then be viewed using viewer terminal 108 by a business executive desiring to obtain knowledge about his/her business through the defined KPIs.

Each of the analyst terminal 102, database administration terminal 104, designer terminal 106, viewer terminal 108 and application server 110 will now be described in greater detail.

Analyst terminal 102 may include a KPI specification application 130 and an implementation application 132. Using KPI specification application 130, a business analyst may provide the requirements for a KPI in a KPI record 172.

KPIs can be metrics for measuring different aspects of business performance that a business analyst may desire to view on a completed dashboard 120. For example, a business analyst may wish to view a KPI that provides a rolling total of monthly sales for the previous 12 months to determine how an organization's sales staff is performing.

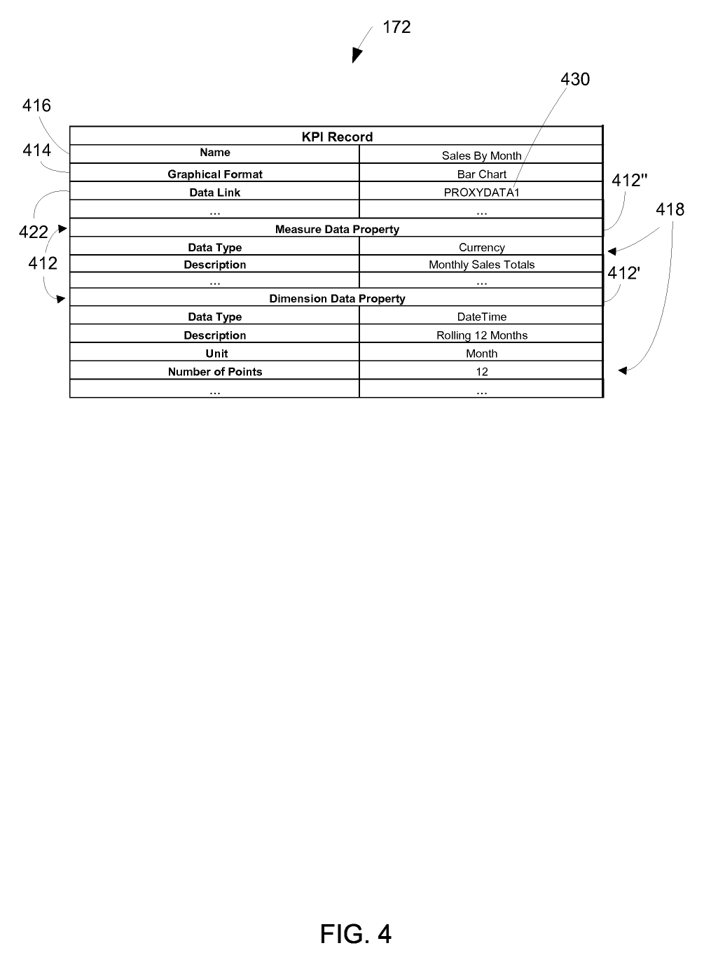

The KPI specification application 130 may allow the specification of such a KPI by including options that allow the business analyst to specify one or more KPI data properties (shown as 412 in FIG. 4) for a KPI. A KPI data property 412 may indicate a constraint on the type of data that is allowable to be associated with a KPI record 172.

Referring briefly to FIG. 4, shown there are two example data properties 412 for an example KPI record 172: a ‘Measure’ data property 412″ and a ‘Dimension’ data property 412′ for an example KPI record 172. Since the KPI specification application 130 performs the function of specifying a KPI, it may also be considered a specifier.

A ‘Measure’ data property 412″ may be the numerical value (e.g., a sales total) being monitored, analyzed or managed in the key performance indicator. A ‘Dimension’ data property 412′ may be the independent units (e.g., a unit of time) for which the ‘Measure’ data property 412″ values are being measured. Various fields 418 of a data property 412 may contain constraints on the type of data being associated with the KPI record 172.

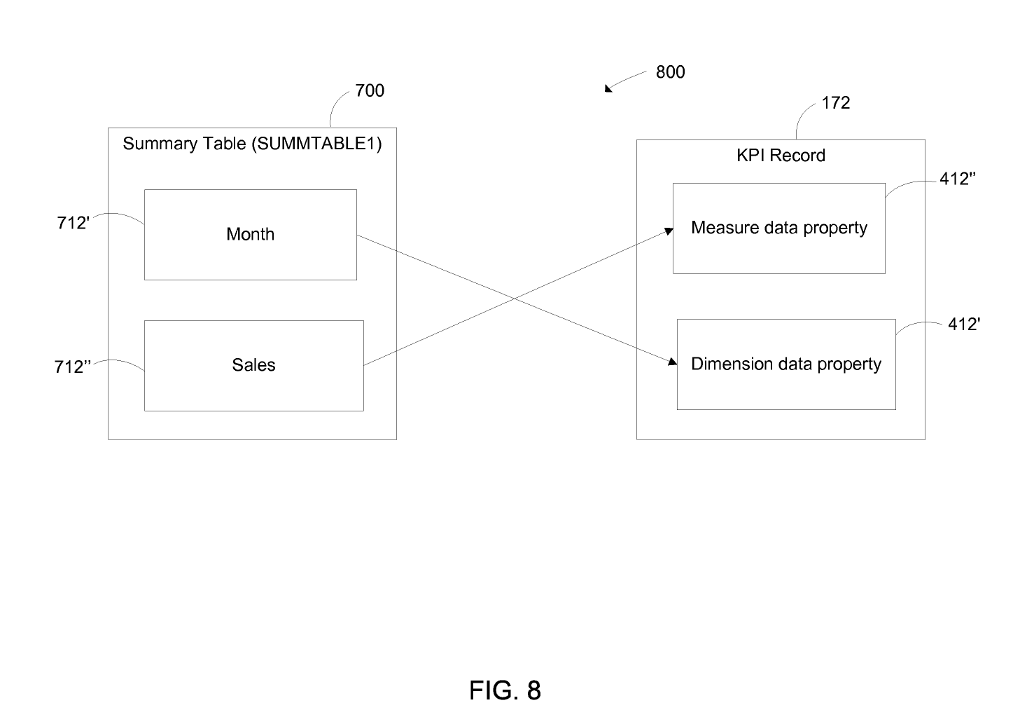

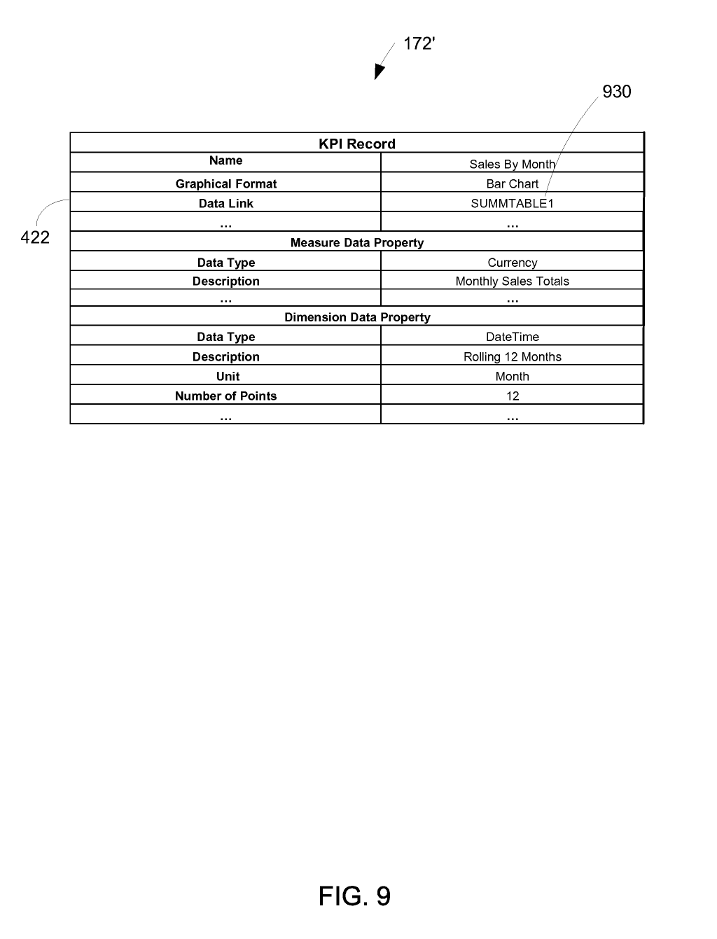

The implementation application 132 may be used, in some embodiments, to replace a proxy link (shown as 430 in FIG. 4) to key performance indicator proxy values 174 in the key performance indicator record 172 with a performance link (shown as 930 in FIG. 9) to derive key performance indicator values 162. This process is described in greater detail below with respect to FIGS. 8 and 9. Since the implementation application 132 performs the function of implementing a KPI (i.e., associating a KPI record 172 with KPI values 162 via a performance link 930), it may also be considered an implementer.

The database administration terminal 104 includes an administration application 140 and a business database 142 (although in some embodiments, the business database 142 may be stored on a separate computer accessible by administration application 140). The business database 142 may store the business data values 144 (e.g., sales, expenses, inventory, human resources, etc.) that relate to the operation of a business. Actual KPI values 162 may be derived from the business data values 144.

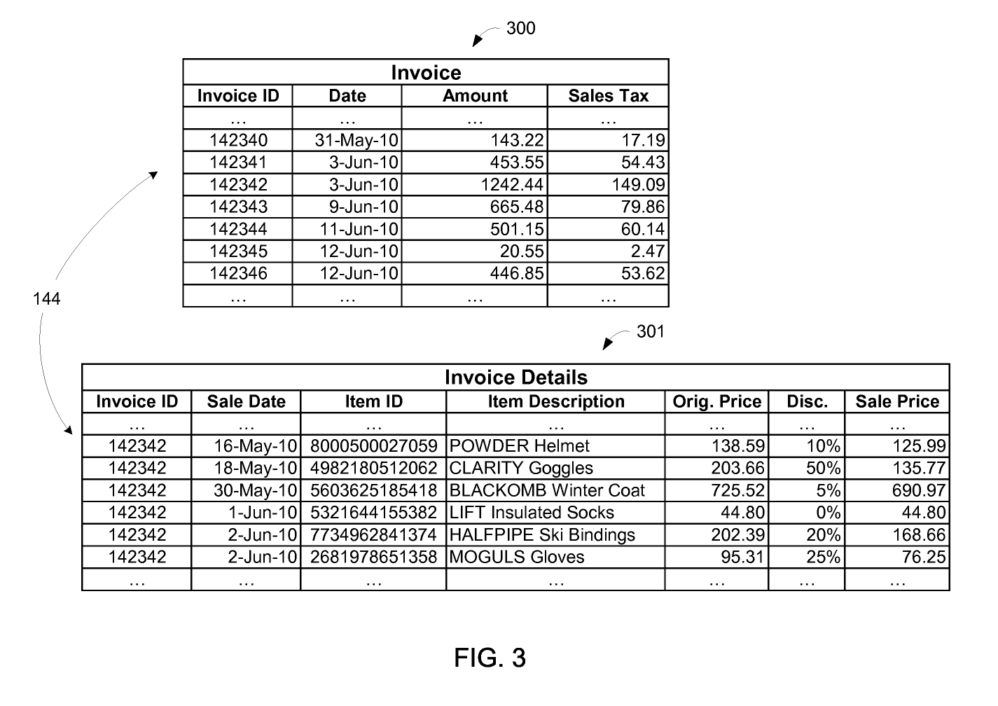

For example, the business database 142 may be an accounting and inventory management control database that stores transactional data for sales. Referring briefly to FIG. 3, shown there are exemplary excerpts from tables 300 and 301 named ‘Invoice’ and ‘Invoice Details’ respectively that may be stored in a business database 142 for an example sporting goods store.

In deriving the KPI values 162 from the business database 142, the database administrator may use the administration application 140 to prepare the data sources. For example, this may include providing the security credentials to access the business database 142 (e.g., a username and/or password), indicating the database provider (e.g., Microsoft® SQL Server), and/or providing other authentication details (e.g., the use of “Windows Integrated Security” for authentication). Since the administration application 140 performs the function of deriving KPI values 162, it may also be considered a deriver.

Designer terminal 106 may include a design application 150, which can be configured to allow a graphic designer to visually design the dashboard 120 by placing the graphical elements 182 corresponding to KPI records 172 on a dashboard design 122.

Graphical elements 182 may be visual representations of KPI values 162 that aid understanding of the data represented by the KPI values 162. Graphical elements 182 may have a key performance indicator graphical format (e.g., a pie chart, a bar chart, graph, text list etc.) that indicates how the data should be visualized. Such graphical format may be selected, for example, to highlight comparisons, relationships (e.g., ratios amongst different types) or trends occurring in the data. Some graphical formats may also display inferences, predictions or projections based on any identified relationships or trends.

Design application 150 may include tools to lay out the graphical elements 182 in a desired fashion, facilitating resizing and/or moving them in a manner desired by the graphic designer. Such process may also involve graphic designers making decisions concerning color or layout. Since the design application 150 performs the function of designing a dashboard design 122, it may also be considered a designer.

Viewer terminal 108 may include a rendering application 152 that is configured to draw, illustrate, depict, or otherwise render the graphical elements 182 in the dashboard design 122 on a computer screen or other device with a suitable display. When a dashboard 120 is complete (i.e., when the proxy link 430 to the KPI proxy values 174 in the KPI record 172 has been replaced by a performance link 930 to actual KPI values 162 derived from the business database 142), a business executive may access rendering application 152 to view the completed dashboard 120 showing the key performance indicator information. The rendering application 152 may be part of a dashboard display application (not shown) that can be configured to communicate the dashboard design 122 to the rendering application 152 when the dashboard 120 is to be displayed. This dashboard display application can be accessed by a business executive when reviewing the performance of his/her business. Since the rendering application 152 performs the function of rendering a dashboard 120, it may also be considered a renderer.

Application server 110 may include the KPI database 170, graphical elements database 180, and optionally, intermediate table database 160 (shown in dotted outline).

The KPI database 170 may store KPI records 172 defined by a business analyst using the KPI specification application 130. The KPI database 170 may also store the generated KPI proxy values 174 linked to the KPI record 172 via the proxy link 430.

The graphical elements database 180 may store graphical elements 182 when a designer is using designer terminal 106. Graphical elements 182 reflect a desired graphical format from KPI records 172. It will be understood that the term “graphical element” is intended to include visual elements appearing on a display, as well as database records storing data corresponding to such visual elements. As such, graphical element database 180 may also store information relating to the visual appearance of a graphical element 182. For example, this may include information relating to the positioning and/or size of a graphical element 182.

The intermediate table database 160 may store derived KPI values 162 from the business database 142 when a database administrator uses database administration terminal 104. The KPI values may be a selected plurality of business values 144 from the business database 142. Alternatively, KPI values 162 can be derived by generating summary values from a selected plurality of business values 144 from the business database 142. These exemplary methods of deriving KPI values 162 will be discussed in greater detail below.

The application server 110 may also include a server-side software component (not shown) that is operable or otherwise configured to interact with the client terminals in the creation of dashboard 120. Such software component may be configured to coordinate the functionality provided in the client terminals by sending and receiving messages on the network 112, and interacting with the databases stored on the application server 110. For example, this may include storing a KPI record 172 corresponding to the requirements of a KPI specified by a business analyst on to KPI database 170.

To more clearly illustrate the operation of the above system 100, an example of the flexibly scheduled dashboard creation process will now be discussed.

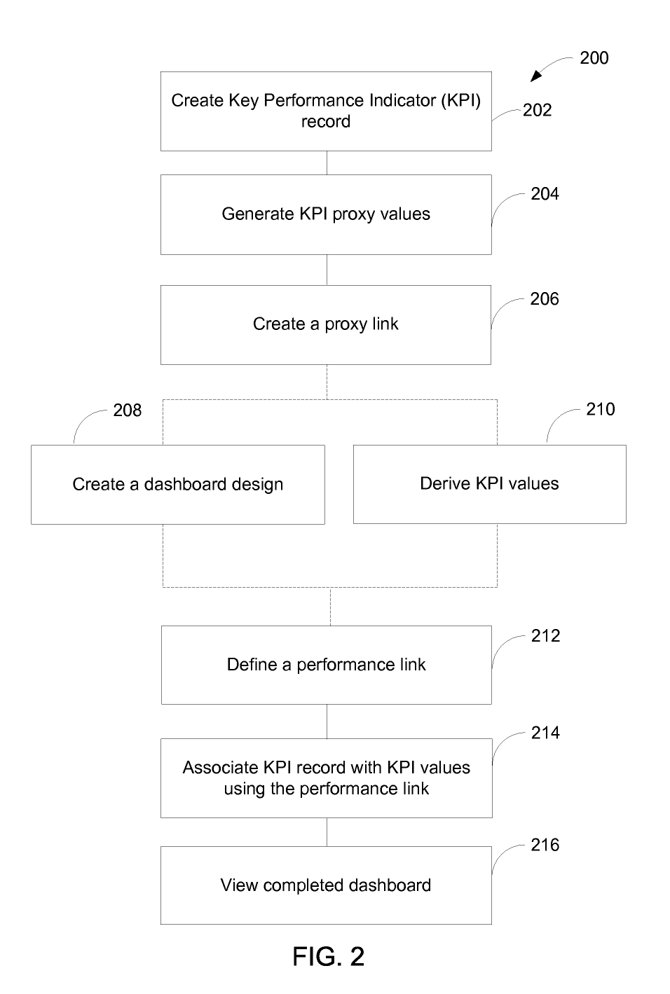

Referring to FIG. 2, there is shown a flowchart, referred to generally as 200, illustrating an example sequence of events for flexibly scheduled creation of a data visualization dashboard 120.

A first step is to create a KPI record 172 (block 202). This may involve a business analyst specifying one or more KPI data properties 412 that reflect the nature of the KPI values 162 that the business analyst desires to view in the completed dashboard 120.

Referring briefly also to FIG. 3, there are schematic illustrations of tables, shown generally as 300 and 301, of business values 144 that may be stored in business database 142 at an example sporting goods store. While business values 144 are illustrated for an example sporting goods store, it will be understood business values 144 may be any data stored in relation to a business.

The ‘Invoice’ table 300 stores data relating to issued invoices, and may include an ‘Invoice ID’ field, a ‘Date’ field, an ‘Amount’ field and a ‘Sales Tax’ field. The ‘Invoice Details’ table 301 stores data relating to details of each transaction record occurring in the ‘Invoice’ table 300, and may include an ‘Invoice ID’ field as a foreign key to the ‘Invoice’ table, a ‘Sale Date’ field, and various details relating to the sold item (e.g., ‘Item ID’, ‘item Description’, ‘Original Price’, ‘Discount’, ‘Sale Price’ and/or ‘Item Tax’). To obtain an understanding of how sales are trending, a business analyst may wish to specify a KPI from this data.

It can be seen that the data stored in the business database 142 may be stored in formats that are not easily accessible by a business analyst to derive the desired KPI values 162. For example, both the ‘Invoice’ table 300 and the ‘Invoice Details’ table 301 may contain various fields that are not needed for specifying a KPI about how sales are trending.

Referring to FIG. 4, shown there is an example KPI record 172 that has been specified by a business analyst. A KPI record 172 may have one or more KPI data properties 412, a preferred or recommended KPI graphical format 414, a name 416, and a data link field 422. As illustrated, the KPI record 172 is shown at a time A when it contains a proxy link 430 associating it with proxy values 174.

KPI data properties 412 may contain various data fields 418 for specifying requirements that the KPI proxy values 174 and KPI values 162 can conform to.

As illustrated, the ‘Sales By Month’ KPI record 172 includes a ‘Measure’ data property 412″ to indicate the numerical sales values that are being measured. Such data property 412″ includes a ‘Description’ field indicating ‘Monthly Sales Totals’ to describe what is being measured. As well, it can contain a ‘Data Type’ field that indicates that the data type of the values associated with the ‘Measure’ data property 412″ is ‘Currency’. As discussed below, the KPI proxy values 174 generated to conform with data property 412″ can then be of the type ‘Currency’.

As alluded to above, the example KPI record 172 may also include a ‘Dimension’ data property 412′ specifying the independent units for which the ‘Measure’ data property values 412′ are being measured. The generated KPI proxy values 174 conforming to this data property 412′ are to be of the type ‘DateTime’ (conforming to the ‘Data Type’ data field), are to have 12 data points (conforming to the ‘Number of Points’ data field), and are to be in units of ‘Months’ (conforming to the ‘Unit’ data field). The ‘Dimension’ data property 412′ may also contain a description entitled “Rolling 12 months” to describe the units for which the ‘Measure’ data property 412′ relates.

For each type of unit specified in the ‘Dimension’ data property 412′, various granularities may be provided. For example, if a ‘Dimension’ data property 412′ specifies its type to be ‘DateTime’, specific units of various granularities (e.g., month, day, year or hour) may be selectable depending on the desired KPI.

The preferred/recommended KPI graphical format 414 for depicting the at least one graphical element corresponding to the KPI record 172 may be specified by the business analyst. In the example, the business analyst has specified the KPI graphical format 414 for the ‘Sale by Month’ KPI to be a ‘Bar Chart’. The KPI graphical format 414 provided in the KPI record 172 can be preferred because the graphic designer may override the format in favour of another format when they are creating the dashboard design 122. For example, this may happen if the designer feels that the data for the ‘Sales by Month’ KPI is better illustrated with a line chart instead of bar chart.

The name 416 of the KPI record 172 has also been specified by the business analyst to be ‘Sales by Month’.

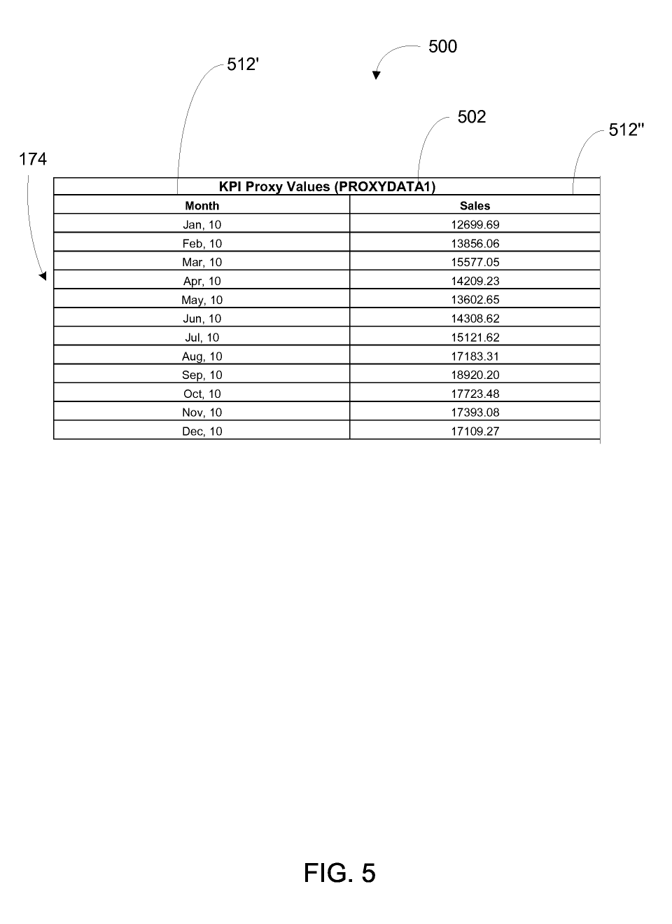

The data link field 422 may be empty when a KPI is initially specified using the KPI specification application 130. It may subsequently be filled with a link to values (either a proxy link 430 to generated KPI proxy values 174 or a performance link 930 to derived KPI values 162) respectively in later steps. As illustrated in FIG. 4, the KPI record 172 is shown at a time A when the data link field 422 contains a proxy link 430 (shown as an identifier “PROXYDATA1” for the KPI proxy values 174 illustrated in FIG. 5).

It will be understood that other forms of a proxy link 430 used for associating the KPI record 172 to KPI values 174 may be possible. For example, this may include storing the memory address, object identifier, pointer or other method of identifying the KPI proxy values 174. Additionally or alternatively, a proxy link 430 may store in a separate storage (not shown), a reference to both the KPI record 172 and KPI values 174. Such variations in implementing a link may also be applicable for the performance link 930 discussed below.

As noted, it is advantageous to start with the definition of the KPI via the KPI record 172 as a first step. Whereas traditional dashboard creation systems may begin with the database administrators constraining the type and amount of data obtained from business database 142, starting with the definition of the KPI avoids such constraints. Without such constraints, business analysts may be able to specify in more precise or accurate terms, the type of data they desire to view in a dashboard 120.

Once a ‘Dimension’ data property 412′ and a ‘Measure’ data property 412″ has been specified, a plurality of KPI proxy values 174 conforming to the KPI data properties 412 of the KPI record 172 may be generated (block 204).

Referring to FIG. 5, shown generally as 500 is a schematic illustration of KPI proxy values 174 conforming to the KPI data properties 412 of the KPI record 172 in FIG. 4. Particularly, the KPI proxy values 174 include a ‘Month’ field 512′ conforming to the ‘Dimension’ data property 412′, and a ‘Sales’ field 512″ conforming to the ‘Measure’ data property 412″.

As specified by the data fields 418 of the ‘Dimension’ data property 412′, the values 512′ conforming to the ‘Dimension’ data field 412′ include twelve data points, and is of the data type ‘DateTime’. Since the ‘Dimension’ data property 412′ further has a data field 418 requiring the proxy values 174 to be in the unit of ‘months’, the values for field 512′ are also in the unit of months without the days shown. Similarly, the values of Sales field 512″ have two decimal places because they are of the data type ‘Currency’ (conforming with the ‘Data Type’ data field in the ‘Measure’ data property 412″). The KPI proxy values 174 may also have an identifier 502 so that the KPI record 172 may be able to form a proxy link 430 with the values.

A proxy link 430 associating the KPI record 172 with the generated plurality of KPI proxy values 174 may then be created (block 206). This may involve setting the data link field 422 in the KPI record 172 to an identifier 502 of the KPI proxy values 174. Referring back to FIG. 4, shown there is the proxy link 430 of the KPI record 172 referring to ‘PROXYDATA1’, an identifier 502 for the KPI proxy values 174 illustrated in FIG. 5. As illustrated, the proxy link 430 is accomplished by setting an identifier in a data link field 422 pointing to the generated proxy values 174.

As intending to be illustrated by the dotted lines in FIG. 2, the ordering of the next two steps (described in relation to blocks 208 and 210) is flexible. That is, a graphics designer may create a dashboard design 122 displaying at least one graphical element 182 corresponding to the KR record 172 (block 208) before, after or in whole or in part simultaneously with, a database administrator's efforts to derive, retrieve, search, calculate or otherwise determine a plurality of KPI values 162 from the data in the business database 142 (with the KPI values 162 conforming to the KPI data properties 412 of the KPI record 172) (block 210).

In block 208, using the KR record 172 and its generated KPI proxy values 174, a graphics designer may create a dashboard design 122 such as design 122 illustrated in FIG. 6. As noted above, creating such a design 122 may involve a graphics designer using the design application 150 to arrange graphical elements 182 corresponding to KPI records 172 in an aesthetically pleasing way, and/or selecting colors and themes.

The design application 150 may also be configured to render the graphical elements 182 to provide a preview or prototype of the dashboard design 122. In some embodiments, such rendering functionality may be the same functionality provided by rendering application 152 in viewer terminal 108.

Referring to FIG. 6, shown there is an example screenshot of multiple graphical elements 182 on a dashboard design 122. As illustrated, there may be a sample text box graphical element 182 for displaying text, as well as other graphical elements 182 (e.g., a pie chart) corresponding to other KPI records 172. Moreover, the dashboard design 122 includes a graphical element 182′ corresponding to the KPI record 172 of FIG. 4. This graphical element 182′ shows a bar chart plotting the generated monthly sales FIG. 612″ for each month 612′ specified by the KPI proxy values 174 (as shown in FIG. 5). In some embodiments, there may be multiple graphical elements 182′ corresponding to the KPI record 172 of FIG. 4. This may happen, for example, if a business analyst desires to view the KPI values 162 for a KPI record 172 in multiple graphical formats.

Since the layout and appearance of graphical elements 182′ are based on the KPI data properties 412 of a KPI record 172 and the derived KPI proxy values 174 instead of actual KPI values 162 from the business database 142, a business analyst may request the designers to start designing the dashboard while the actual KPI values 162 are being derived by a database administrator from business values 144 in business database 142. In this way, the graphic designer and the database administrator can work in parallel to expedite dashboard creation.

An additional advantage may be that since the graphic designer may view a realistic impression of how the dashboard 120 will ultimately look using the KPI proxy values 174, the graphic designer may be able to make better design decisions for the dashboard design 122.

Furthermore, the ability to create a dashboard design 122 from KPI proxy values 174 may facilitate quicker prototyping of a dashboard 120. That is, in some cases, a graphic designer may be able to generate a prototype of a dashboard 120 without requesting database administrators to select the KPI values 162 from the business database 142. If the business analyst is satisfied with the prototype of the dashboard 120, only then may they need to involve the database administrators to derive the KPI values 162 from the business database 142.

It will be understood that in various embodiments, additional details of the graphical elements 182 may be specified in the KPI record 172. For example, the scale on the ‘Measure’ data property 412″ (the data for which is shown running on the vertical axis of the bar chart graphical element 182′) may be configurable. Additionally or alternatively, some or all of these details may be automatically generated or stored in the graphical element 182.

As noted above, in block 210, a database administrator may then be able to operate administration application 140 to derive, search, retrieve or otherwise obtain KPI values 162 that conform to the KPI data properties 412 of the KPI record 172. In performing this step, the database administrator may have to set up connections to, and/or run specialized queries on, business database 142 to retrieve and format the data in a way that conforms with the KPI data properties 412 of the KPI record 172.

In the example, a database administrator may wish to derive KPI values 162 from the example business values 144 illustrated in FIG. 3. Such derivation may be performed so that each KPI proxy value 174 corresponds to at least one of the plurality of KPI values 162.

The database administrator could (using administration application 140) select a plurality of business values 144 from the ‘Invoice’ table 300 and ‘Invoice Details’ table 301 in the business database 142. Such selection may require the expertise of database administration personnel because they would be familiar with the database schema to know the appropriate database table from which to select such data. For example, of the two tables shown in FIG. 3, a database administrator would know to look in the ‘Invoice Details’ table 301 to derive monthly sales total data for the KPI record 172 illustrated in FIG. 4.

In some cases, after selecting such business values 144 from the business database 142, the database administrator may use administration application 140 to generate one or more summary values corresponding to the selected plurality of the business values 144. A summary value may be any value that corresponds to a condensed or processed version of the selected business values 144 that highlights one or more aspects of the selected business values 144. For example, a summary value may be the result of performing a calculation or other analytical procedure (e.g., summation, average) on the selected business values 144.

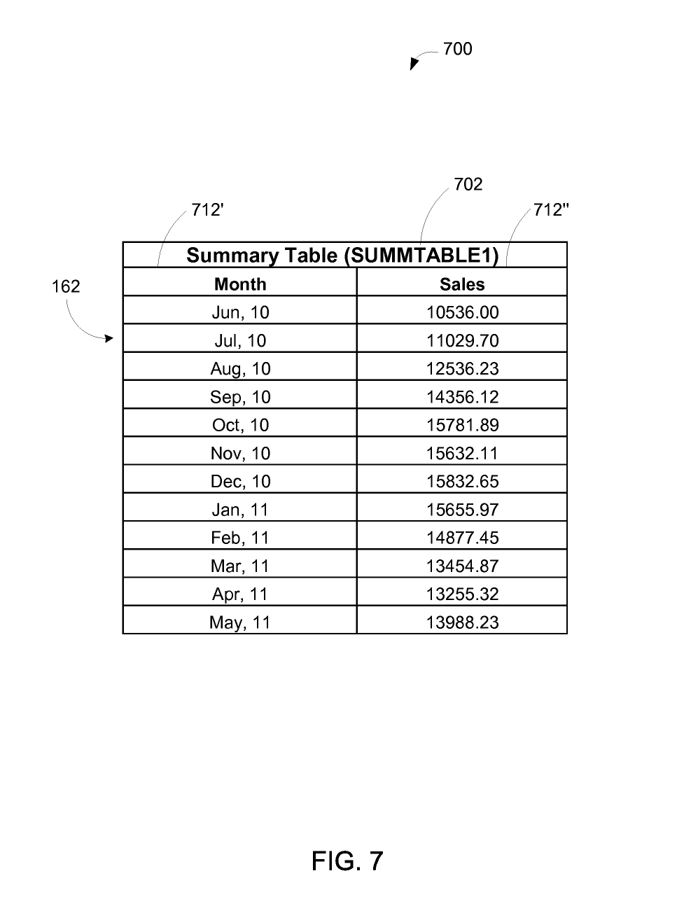

Referring to FIG. 7, illustrated generally as 700 is a schematic illustration of an example table containing KPI values 162 for the KPI record 172 illustrated in FIG. 7. The KPI values 162 have a similar format as the KPI proxy values 174 illustrated in FIG. 5 because both sets of values conform to the KPI data properties 412 specified in KPI record 172 of FIG. 4.

As illustrated, the KPI values 162 include summary values, with at least one summary value corresponding to a portion or subset (which may include all) of the selected plurality of business values 144 from business database 142. Analytical procedures have been performed on the business values 144 selected from the business database 142. It can be seen that sales for each month from June, 10 to May, 11 have been selected and summed to provide the total sales for each month in the ‘Sales’ field 712″. Similarly, each record in the summary table 700 contains a ‘Month’ field 712′ to indicate the month for which the monthly sales were for. It will be understood that while the KPI values 162 are shown as a table in FIG. 7, the generated KPI values 162 need not be in a table format.

In one embodiment, the summary KPI values 162 may be generated by executing an SQL query on the business database 142. The SQL query may be created by the database administrator using database administration terminal 104. The database administrator may be able to create the SQL query because of their specialized knowledge of the business database 142.

As is known in the art, an SQL query may identify one or more tables in the business database 142 from which to select business values 144. In doing so, multiple tables may be joined together to collate the necessary data. Also, an SQL query may specify functions (e.g., summation, average, count, maximum, minimum, etc.) as analytical procedures to perform calculations on the business values 142. Additionally or alternatively, SQL functions may further be used, to sort, restrict, or aggregate the business values 148.

In the example, the SQL query for deriving the summary KPI values 162 in FIG. 7 from the business values 144 illustrated FIG. 3 may be:

SELECT [Sale Date].Month AS “Month”, SUM([Sale Price]) AS “Sales”

FROM [Invoice Details]

GROUP BY [Sale Date].Year, [Sale Date].Month

This SQL query may perform the following: identify the ‘Invoice Details’ table 301; group selected values from those tables according to an item's sale date; and sum up the sales amounts for items sold in a given month.

Since the query identifies the subset or portion of the selected plurality of business values 144 that a summary value corresponds to, the query can be considered a summary link that links the summary KPI values 162 and the business values 144 through the instructions provided in the query on how to derive such summary values from the business values 144. The summary link can also be considered a summary definition or specification because it defines/specifies how summary values may correlate to a selected plurality of business values 144. In some embodiments, this summary link may be stored in the intermediate table database 160.

Additionally or alternatively, the KPI values 162 may be stored in an intermediate table database 160 on application server 110 to provide efficient temporary access to the KPI values 162 on the server 108. In such embodiments, the KPI values 162 may be cached and be periodically updated.

In some embodiments, the values stored in the intermediate table database 160 may be considered intermediate data values. In such case, a business analyst may further refine, summarize, or otherwise condense the intermediate data values to derive the eventual KPI values 162 associated with the KPI record 172.

As indicated above, intermediate database 160 may be optional. In embodiments without intermediate database 160, the summary link may be stored in the KPI database 170 and the KPI values 162 may be dynamically derived from the business database 142 using the summary link when required. That is, an SQL query may be executed to retrieve the summary KPI values 162 when requested, without the results of the query being stored in an intermediate database 160.

While the illustrated example of FIG. 7 contains summary values, it should be understood that in some cases, a database administration (using administration application 140) may identify KPI values 162 directly from the selected plurality of business values 144 themselves. In such case, an SQL query may not perform any analytical procedures on the selected business values 144 so that the KPI values 162 may be identified directly from the selected business values 144. Similar to the case with the use of summary values, the fields of the identified KPI values 162 selected directly from the business values 144 themselves may also conform to the KPI data properties 412 of a KPI record 172.

Once the KPI values 162 conforming to the KPI data properties 412 of the KPI record 172 have been derived, and the dashboard design 122 containing graphical elements 182 corresponding to the KPI record 172 have been created, a dashboard design 122 may be finalized to complete the dashboard creation process. This may involve defining a performance link (block 212) and associating the KPI record 172 with the derived KPI values 162 using the performance link (block 214).

In one embodiment, the association may involve operating the implementation application 132 to replace or otherwise substitute the proxy link 430 associating the KPI record 172 with the KPI proxy values 174 with a performance link 930 associating the KPI record 172 with the derived KPI values 162.

Alternatively, block 214 may involve adding the performance link 930 to a KPI record 172 (without deleting the proxy link 430), and configuring the graphical element 182 to refer to the performance link 930 when retrieving KPI values 162 to display.

In some embodiments, the performance link 930 associating the KPI record 172 with the KPI values 162 may not be stored in the KPI record 172 itself, and may instead be stored apart from the KPI record 172. In such case, the graphical element may be configured to reference the performance link 930 to retrieve the KPI values 162 when depicting them in the graphical element 182.

As a part of the implementation process, a business analyst may be able to use the implementation application 132 to map the fields of the derived KPI values 162 to the KPI data properties 412 of the KPI record 172.

Referring to FIG. 8, shown there is a schematic illustration, referred to generally as 800, of the mapping operation of the implementation application 132. In the example, the derived KPI values 162 in the summary table 700 of FIG. 7 are being associated with the KPI record 172 via a performance link 930 (described below). As such, the fields 712′, 712″ of the summary table 700 (shown as boxes in the summary table 700 block) are mapped to the data properties 412′, 412″ of the KPI record 172 (shown as boxes in the KPI record 172 block). This mapping process is illustrated pictorially in FIG. 8 with arrows pointing from the ‘Month’ field 712′ to the ‘Dimension’ data property 412′, and from the ‘Sales’ field 712″ to the ‘Measure’ data property 412″.

Additionally or alternatively, the implementation application 132 may be able to perform the mapping in an automated fashion. To enable such automatic mapping, KPI data properties 412 of a KPI record 172 may specify an identifier that can be used in the field name of the KPI values table (in the example, summary table 700 illustrated in FIG. 7) to automatically match the name of the field with the identifier for a respective KPI data property 412. The implementation application 132 may then examine the field names of the KPI values table and automatically match the field in the KPI values table with the KPI data property 412 that the KPI values 162 are designated as conforming to. It will be understood that in such embodiment, the KPI specification application 130 may be configured to not allow any duplicates in the naming of KPI data property 412 identifiers.

After the mapping is complete, the proxy link 430 associating the KPI record 172 with the KPI proxy values 174 may be replaced with a performance link 930 associating the KPI record 172 with the KR values 162.

Referring to FIG. 9, shown generally as 172′ is an updated version of the KPI record of FIG. 4 at a second point in time after time A, time B. At this time, the proxy link 430 to the KPI proxy values 174 have been replaced with a performance link 930 to the KPI values 162. This is illustrated by the data link field 422 having been updated to refer to the identifier 702 (“SUMMTABLE1”) of summary table of FIG. 7 instead of the identifier 502 (“PROXYDATA1”) for the KPI proxy values in FIG. 5

The step of associating the KPI record 172 with the KPI values 162 using the performance link 930 completes the dashboard 120 creation process. In some instances, this involves replacing the proxy link 430 to the KPI proxy values 174 with a performance link 930 to actual derived KPI values 162. After the proxy link 430 is replaced, the KPI record 172 ceases to refer to “stubbed” or fake data (i.e., proxy values 174) and becomes a regular or completed KPI record 172, referring to actual KPI values 162. In this way, when the KPI record 172 refers to the KPI proxy values 174, it can also be considered a ‘KPI proxy record’ or a ‘KPI stub’.

In some embodiments, such KPI proxy record and KPI record may be separate records. In such configuration, replacing the proxy link 430 with the performance link 930 may first include making a copy of the KPI proxy record, and then replacing the proxy link 430 in the copy so that the copy becomes the eventual KPI record 172 with the performance link 930.

The completed dashboard can then be viewed by a business executive using rendering application 152 on viewer terminal 108 (block 216).

Referring to FIG. 10, shown there is an example screenshot of a completed dashboard 120. As compared with the dashboard design 122 illustrated in FIG. 6, it can be seen that the graphical elements 182 have been updated with actual KPI values 162 derived from the business database 142. For example, the text box formerly containing “SAMPLE TEXT” has now been replaced with text relevant to business performance, i.e., “2011 Q2 SALES UPDATE”. Similarly, the pie chart graphical element 182 illustrating ‘Transactions by Region’ has also been updated with actual derived KPI values 162.

The completed dashboard 120 also contains a bar chart graphical element 182′a corresponding to the updated KPI record 172′ of FIG. 9 at time B. As illustrated, it can be seen that the graphical element 182′ of FIG. 6 formerly illustrating the KPI proxy values 174 illustrated in FIG. 5 has been updated with the graphical element 182′a to depict the derived KPI values 162 illustrated in FIG. 7. That is, the months 1012′ along the horizontal axis of the bar chart now illustrate the data for the ‘Month’ field 712′ and the illustrated monthly sales FIG. 1012″ now illustrate the data of the ‘Sales’ field 712″.

In some embodiments, the graphical element 182′ in the dashboard design 122 of FIG. 6 may contain a reference to the KPI record 172 that it corresponds to. This may, for example, be useful if the graphical element 182′ can be operable or otherwise configured to depict both the KPI proxy values 174 and the KPI values 162. In such case, the graphical element 182′a in the completed dashboard 120 of FIG. 9 may be the same graphical element 182′ of FIG. 6 (i.e., the same user interface object) with its visual appearance updated to reflect the KPI values 162 shown in FIG. 7.

In further embodiments, the graphical element 182′a in a completed dashboard 120 may be configured to appear visually distinct from its corresponding dashboard design 122 so as to provide an aid in determining whether a dashboard design 122 is complete. For example, graphical element 182′a in FIG. 10 has been illustrated with the solid vertical bars illustrating the monthly sales figures to indicate that the graphical element 182′a depicts actual KPI values 162. In comparison, the vertical bars in the dashboard design 122 depicting KPI proxy values 174 illustrated in FIG. 6 only contain an outline for the vertical bars. It will be understood that other mechanisms to create a visual distinction may also be used, such as, for example, using a watermark on the dashboard design 122 to indicate that it is depicting KPI proxy values 174.

Notwithstanding such visual distinctions, it will be noted that since both the KPI proxy values 174 illustrated in FIG. 5 and the actual derived KPI values 162 illustrated in FIG. 7 conform to the KPI data properties 412 of the KPI record 172 shown in FIG. 4, the completed dashboard 120 appears substantially similar to the dashboard design 122 shown in FIG. 6 when previewed using KPI proxy values 174.

It will be understood by persons skilled in the art that variations are possible in variant implementations and embodiments of the described dashboard creation system 100. Such variations include, but are not limited to, variations in the connectivity amongst described components, the sequence of execution by the described components, the organization of described components, as well as the data structures and types of data stored.

For example, referring again to FIG. 4, in some embodiments, the KPI specification application 130 may allow a business analyst to specify additional data fields 418 and/or additional KPI data properties 412.

For example, additional data fields 418 may include data fields 418 that the KPI proxy values 174 are to conform to, but that the derived KPI values 162 need not conform to. This may include a ‘Data Trend’ field (not shown) of the ‘Measure’ data property 412″ which indicates how KR proxy values 174 should be generated. The setting of such ‘Data Trend’ field may allow a business analyst to preview how the visual aspects of the graphical element 182 corresponding to the KPI record 172 appears if data trends are present in the derived KPI values 162.

Data trends may, for example, be ‘Random’ to indicate that the generated proxy values 162 for the ‘Measure’ data property are generated in a random fashion. As illustrated in FIG. 5, the generated KPI proxy values 174 for the ‘Monthly Sales Totals’ KPI of FIG. 4 are shown as being of a random nature.

Other data trends that can be specified may include ‘Increasing’, ‘Decreasing’, or ‘Flat’ to generate KPI proxy values 174 that are increasing, decreasing or flat respectively. In the example of the discussed ‘Sales by Month’ KPI, an ‘increasing’ data trend may show an increasing monthly sales total for each progressive month to provide a preview of how such data would appear in a dashboard 120. Similarly, a ‘decreasing’ data trend would show decreasing monthly sales totals for each progressive month in the generated KPI proxy values 174. A ‘flat’ data trend would show monthly sales total that do not change for all the months of the generated KPI proxy values 174.

These data fields 418 may be flagged with a special marker so that they can be identified by the implementation application 132.

In such embodiment, the KPI record 172′ of FIG. 9 for a completed dashboard 120 may be a newly created KPI record 172 that copies the fields 418 of the KPI record 172 of FIG. 4. In doing so, the implementation application 132 may avoid the flagged data fields 418 that only the KPI proxy values 174 need to conform to (e.g., a ‘Data Trend’ data field) so as not to copy those fields to the KPI record 172′ for a completed dashboard 120.

In some embodiments, the KPI specification application 130 may allow a business analyst to specify additional KR data properties 412 for a KPI record 172. This may include a contextual metric data property 412 that provides contextual information for a ‘Measure’ data property 412″. In the example of the ‘Sales by Month’ KPI discussed above, contextual information may be a set of data values that help in analyzing the KPI values 162 such as historical sales figures for the same month in the previous year. Similar to other KPI data properties 412, KPI proxy values 174 may be generated and KPI values 162 may be derived to conform to a contextual metric data property 412.

A particular type of contextual metric data property 412 may be a summary value data property 412. For example, a summary value data property 412 may specify that the KPI proxy values 174 and the KPI values 162 include an average of the values generated or derived respectively for the ‘Measure’ data property 412″.

When a summary value data property 412 is specified in a KPI record 172, the generated KPI proxy values 174 may have a column of data conforming to the summary value data property 412. This data may be displayed in a dashboard design 122 to provide a preview of how summary values would appear in a final completed dashboard 120.

Similarly, the derived KPI values 162 would also have a column of data conforming to the summary value data property 412. The implementation application 132 may then allow a business analyst to map such column onto the summary value data property 412 so that when the proxy link 430 associating the KPI record 172 with the KPI proxy values 174 is replaced with the performance link 930 associating the KPI record 172 with the KPI values 162, the column of data for the derived summary values may be displayed in the completed dashboard 120.

In further embodiments, the ‘Number of Points’ data field 418 illustrated as a part of the ‘Dimension’ data property 412′ in FIG. 4 may be stored as a separate data property 412 in the KPI record 172. In such case, the ‘Number of Points’ data property 412 may be configured so that only the KPI proxy values 174 may have to conform to it. That is, in such embodiments, while the KPl proxy values 174 may have a number of points correspond to the number specified by this data property, the derived KPI values 162 need not have the same number of points. The graphical element 182 corresponding to the KPI record 172 in the completed dashboard 120 can then be configured to depict the number of data points that the KPI values 162 include. If the derived KPI values 162 contain more data points than can be viewed, the graphical element 182 can be configured to only depict a minimum number of data points.

In further variant embodiments, it will be understood that while FIG. 1 illustrates each of the various user roles as being performed by separate applications executing on analyst terminal 102, database administration terminal 104, designer terminal 106 and viewer terminal 108, the illustrated KPI application 130, implementation application 132, administration application 140, design application 150, and rendering application 152 may be provided in a single application accessible on one or more terminals. This may be in the form of a standalone executable or a web application accessible through a web browser, using methods known in the art. It will further be understood that the functionality provided by rendering application 152 on viewer terminal 108 need not be performed by a separate rendering application 152 on a separate viewer terminal 108, and may also be incorporated into one or more other of the KPI specification application 130, implementation application 132, administration application 140, or design application 150. Other system configurations and methodologies may be employed as will be understood.

In some embodiments, the generated KPI proxy values 174 may not be stored in KPI database 170. For example, this may be the case if the KPI proxy values 174 are dynamically generated each time the designer application 150 is accessed by the graphic designer. In such embodiments, the KPI proxy values 174 may reside in the memory of the designer terminal 106 and the proxy link 430 may refer to the memory address or object identifier of where the KPI proxy values 174 are stored. In such embodiments, new and different KPI proxy values 174 may be generated and linked to in subsequent previews of the dashboard design 122.

While the term ‘database’ has been used herein, it will be understood that variant methods of achieving persistent storage can be used. Such methods may, for example, include storing the indicated records and data as a specified folder or file format on a hard disk. As such, the term ‘database’ may also be generally referred to as storage. Similarly, while the term ‘application’ has been used herein, it will be understood that variant methods of achieving the described software functionality may be used. For example, the ‘applications’ may be different software components or modules configured to perform or provide remote access to the described functionality.

The steps of a method in accordance with any of the embodiments described herein may be provided as executable software instructions stored on computer-readable media, which may include transmission-type media. Such steps may not be required to be performed in any particular order, whether or not such steps are described in claims or otherwise in numbered or lettered paragraphs.

The invention has been described with regard to a number of embodiments. However, it will be understood by persons skilled in the art that other variants and modifications may be made without departing from the scope of the invention as defined in the claims appended hereto.

1. A method for generating dashboards displaying key performance indicator information, the method comprising:
a) creating a key performance indicator record;
b) generating a plurality of key performance indicator proxy values;
c) creating a proxy link associating the key performance indicator record with the plurality of key performance indicator proxy values;
d) creating a dashboard design displaying a graphical element corresponding to the key performance indicator record;
e) deriving a plurality of key performance indicator values from a business database, wherein each key performance indicator proxy value corresponds to at least one of the plurality of key performance indicator values;
f) defining a performance link; and
g) associating the key performance indicator record with the plurality of key performance indicator values using the performance link.

2. The method of claim 1, further comprising communicating the dashboard design to a renderer configured to render the graphical element.

3. The method of claim 1, wherein the dashboard design displays a plurality of graphical elements corresponding to the key performance indicator record.

4. The method of claim 1, wherein the graphical element corresponds to the plurality of key performance indicator values.

5. The method of claim 1, wherein said deriving comprises:
a) selecting a plurality of business values from the business database.

6. The method of claim 5, wherein the key performance indicator values correspond to a subset of the selected plurality of the business values.

7. The method of claim 5, further comprising:
a) generating a summary value, wherein the summary value corresponds to a subset of the selected plurality of business values.

8. The method of claim 7, wherein at least one key performance indicator value corresponds to the summary value.

9. The method of claim 1, wherein the key performance indicator record comprises at least one key performance indicator data property.

10. The method of claim 9, wherein at least one key performance indicator proxy value conforms to the at least one key performance indicator data property.

11. The method of claim 9, wherein at least one of the derived plurality of the key performance indicator values conforms to the at least one key performance indicator data property.

12. A dashboard generated according to the method of claim 1.

13. A system for creating a dashboard displaying key performance indicator information, the system comprising:
a) a key performance indicator record;
b) a proxy link associating the key performance indicator record with a plurality of generated key performance indicator proxy values;
c) a business database storing a plurality of business values;
d) a deriver operable to derive a plurality of key performance indicator values from the plurality of business values, wherein each key performance indicator proxy value corresponds to at least one of the derived plurality of key performance indicator values; and
e) an implementer operable to: define a performance link, and associate the key performance indicator record with the plurality of key performance indicator values using the performance link.

14. The system of claim 13, further comprising a renderer configured to render a dashboard design, the dashboard design comprising a graphical element corresponding to the key performance indicator record.

15. The system of claim 13, wherein the implementer is operable to replace the proxy link with the performance link.

16. The system of claim 13, wherein the key performance indicator record comprises a key performance indicator graphical format for depicting the graphical element.

17. The system of claim 13, wherein the graphical element corresponds to at least one selected from the group of: the key performance indicator proxy values and the key performance indicator values.

18. The system of claim 13, further comprising a key performance indicator storage for storing at least one selected from the group of: the key performance indicator record and the proxy link.

19. The system of claim 13, wherein the deriver is operable to select a plurality of business values from the business database.

20. The system of claim 19, wherein the key performance indicator values correspond to a subset of the selected plurality of business values.
